(19) United States
(12) Patent Application Publication
(10) Pub. No.: US 2017/0299219 A1
(43) Pub. Date: Oct. 19, 2017

(54) AIR DELIVERY SYSTEM

(71) Applicant: TIGERS POLYMER CORPORATION, Osaka (JP)

(72) Inventors: Seisuke OKABE, Hyogo (JP); Shunsuke SAKATA, Hyogo (JP)

(21) Appl. No.: 15/469,783

(22) Filed: Mar. 27, 2017

(30) Foreign Application Priority Data
Apr. 18, 2016 (JP) 2016-083075

(51) Int. Cl. F24F 13/22; F16K 1/38

(52) U.S. Cl. CPC F24F 13/222; F16K 1/38; F24F 13/22; F25D 21/14

(57) ABSTRACT

An air delivery system includes a drain valve. The drain valve includes a flexible valve body, and a base portion. The valve body includes a valve main portion having a substantially disk-like and conical surface-like shape. The base portion includes a drain hole, and a ring-like region on a surface of the base portion. The ring-like region has a diameter which is smaller than a diameter of the valve main portion, and surrounds the drain hole. The valve body is fitted to the base portion such that the valve main portion covers the drain hole. When the drain valve is closed, the base portion abuts against the valve main portion at the ring-like region, and a peripheral portion, of the valve main portion, which is located in the outer periphery portion than the ring-like region, is spaced apart from the surface of the base portion.

### CROSS-REFERENCE TO RELATED APPLICATION

This application claims priority from Japanese Patent Application No. 2016-083075 filed with the Japan Patent Office on Apr. 18, 2016, the entire content of which is hereby incorporated by reference.

### BACKGROUND

### 1. Technical Field

The present disclosure relates to an air delivery system.

### 2. Related Art

There are known an air conditioning apparatus, an air cooling apparatus, and the like each having a hole and a valve body for discharging water having intruded into the air delivery system. Also, in an internal combustion engine for automobiles or the like, air is supplied to the internal combustion engine through an intake system including an intake tube, an air cleaner, a silencer, and the like. Heavy wind and rain, flood on a road, and the like sometimes cause water to intrude into the intake system. For this reason, a drain hole is often disposed to the air cleaner and the silencer for preventing water from being accumulated inside.

Also, the drain hole is sometimes provided with a drain valve, such that when a vehicle travels in a flood region, water is prevented from conversely intruding inside through the drain hole. For example, JP-UM-A-05-50062 discloses a technology of disposing a dewatering valve (drain valve) which is configured to abut against a dust pan of an air cleaner at a ring-shaped edge portion. It is disclosed that according to the dewatering valve, sealing properties are not likely to deteriorate.

### SUMMARY

An air delivery system according to an embodiment of the present disclosure includes a drain valve. The drain valve includes a flexible valve body made of an elastic material, and a base portion. The valve body includes a valve main portion having a substantially disk-like and conical surface-like shape. The base portion includes a drain hole through which water passes, and a ring-like region on a surface of the base portion. The ring-like region has a diameter which is smaller than a diameter of the valve main portion having the substantially disk-like shape, and surrounds the drain hole. The valve body is fitted to the base portion such that the valve main portion covers the drain hole, and allows water having intruded into the air delivery system to be discharged while inhibiting water from the outside of the air delivery system from intruding. When the drain valve is closed, the base portion abuts against the valve main portion at the ring-like region, and a peripheral portion, of the valve main portion, which is located in the outer periphery portion than the ring-like region, is spaced apart from the surface of the base portion.

### BRIEF DESCRIPTION OF DRAWINGS

FIG. 1 is a cross-sectional schematic diagram illustrating an example in which an air delivery system according to a first embodiment is applied to an intake system;

FIG. 2 is a schematic diagram illustrating a configuration of a drain valve of the air delivery system according to the first embodiment;

FIG. 3 is a cross-sectional diagram illustrating a structure of the drain valve of the air delivery system according to the first embodiment;

FIG. 4 is a cross-sectional diagram illustrating another structure example of a drain valve of an air delivery system according to a second embodiment;

FIG. 5 is a schematic diagram illustrating a flutter of a valve body in a drain valve of a known air delivery system; and

FIG. 6 is a diagram illustrating the noise measurement result which indicates an unusual noise preventing effect by the air delivery system according to the first embodiment.

### DETAILED DESCRIPTION

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

It became apparent that in a known air delivery system, there is a risk that an unusual noise may be generated associated with the opening and closing of a drain valve. Especially, in an intake system of an internal combustion engine, pulsations of sucked air occur in accordance with intake cycles of an internal combustion engine. It became apparent that this sometimes causes significant pressure fluctuation to occur associated with intake pulsations in a part including a drain valve at a specific engine rotational speed, which leads to repeated opening and closing of the drain valve, thereby to generate an unusual noise. Especially, when a drain valve is disposed to a resonator, such an unusual noise is likely to be generated.

An object of the air delivery system according to the present embodiment is to suppress the generation of an unusual noise when cyclic pressure variations act.

As a result of intensively conducted research, the present inventors found that the generation of an unusual noise attributable to pressure variations can be suppressed by allowing a specific site of a base portion to abut against a specific site of a valve body having a predetermined shape for sealing the site. Thus, the air delivery system according to the present embodiment has been achieved.

An air delivery system according to the present embodiment includes a drain valve. The drain valve includes a flexible valve body made of an elastic material, and a base portion. The valve body includes a valve main portion having a substantially disk-like and conical surface-like shape. The base portion includes a drain hole through which water passes, and a ring-like region on a surface of the base portion. The ring-like region has a diameter which is smaller than a diameter of the valve main portion having the substantially disk-like shape, and surrounds the drain hole. The valve body is fitted to the base portion such that the valve main portion covers the drain hole, and allows water having intruded into the air delivery system to be discharged while inhibiting water from the outside of the air delivery system from intruding. When the drain valve is closed, the base portion abuts against the valve main portion at the ring-like region, and a peripheral portion, of the valve main portion, which is located in the outer periphery portion than the ring-like region, is spaced apart from the surface of the base portion (first aspect).

In the first aspect, preferably, the base portion abuts against a surface, of the valve main portion having the conical surface-like shape likened to an umbrella, which corresponds to the inner portion of the umbrella (second aspect). Moreover, in the first or second aspect, preferably, when the diameter of the ring-like region is DB, and the diameter of the valve main portion is DV, the ratio between the DV and the DB satisfies the condition of 1.05≦DV/DB≦1.25 (third aspect).

According to the air delivery system of the first aspect, the generation of an unusual noise attributable to cyclic pressure variations can be suppressed. Also, according to the air delivery system of the second or third aspect, the effect of suppressing the generation of an unusual noise is enhanced.

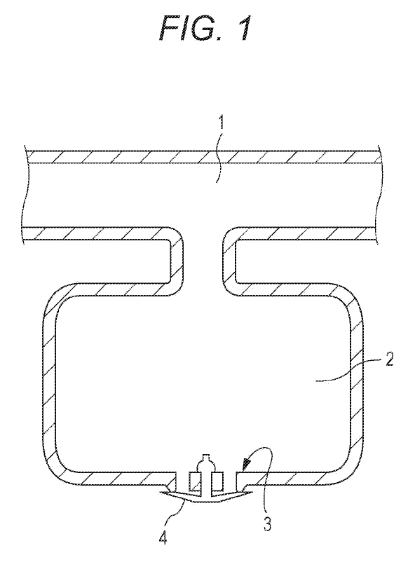

Hereinafter, the present embodiment will be described with reference to the drawings, with an air delivery system applied to an intake system of an internal combustion engine for automobiles as an example. The present embodiment is not limited to the following individual embodiments. The embodiments can also be appropriately modified. FIG. 1 is a cross-sectional schematic diagram illustrating an example of an air delivery system according to a first embodiment which is applied to an intake system. FIG. 1 illustrates only the part of an intake tube and a silencer (a Helmholtz-type resonator) in the intake system. Other parts such as an air cleaner are omitted.

In the intake system, air which flows through an intake tube (intake duct) 1 is supplied to an internal combustion engine through an air cleaner or the like. In the present embodiment, a Helmholtz-type resonator 2 is disposed in such a manner as to be branched from the intake tube 1. A drain valve is arranged at a lower portion of the resonator 2. In an intake system, the site to which a drain valve is arranged is not limited to a silencer. A drain valve may be arranged, for example, at a lower portion of a chamber of an air cleaner or at a lower portion of an intake tube.

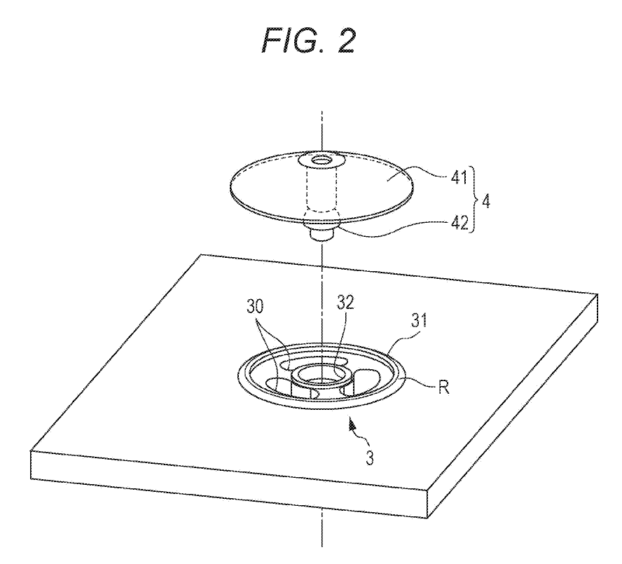

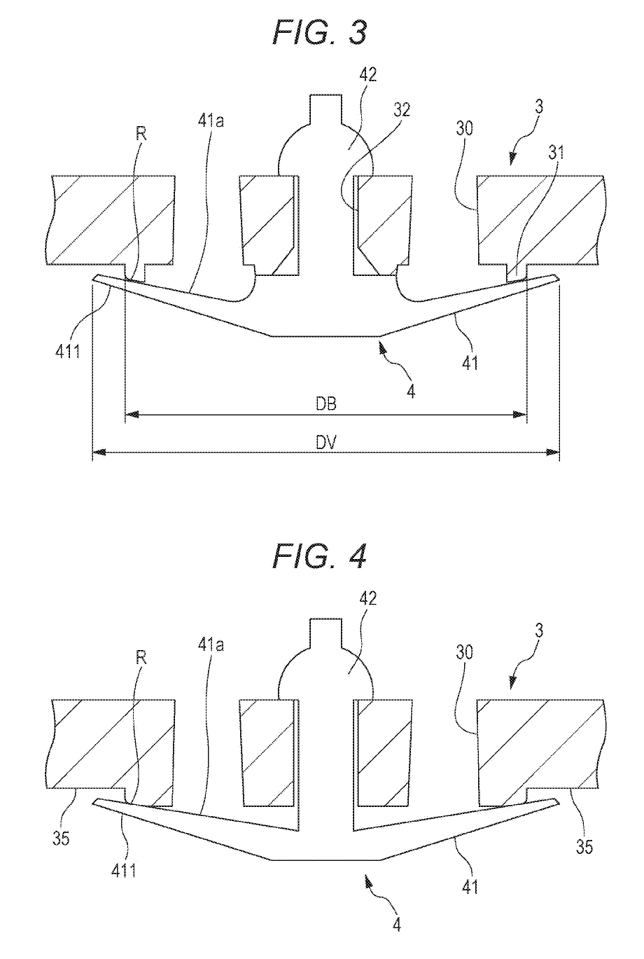

As illustrated in FIG. 2 and FIG. 3, the drain valve includes a valve body 4 and a base portion 3. The drain valve is configured in such a manner as to be openable and closable when the valve body 4 is fitted to the base portion 3. Also, the valve body 4 is mounted to the outer surface side of the resonator 2. It is noted that FIG. 2 illustrates that the valve body 4 is to be mounted to the base portion 3 from outside of the outer periphery portion of the resonator case.

The valve body 4 is made of an elastic material, and therefore has flexibility. As the elastic material, a rubber material or a thermoplastic elastomer material is typically used. Examples of a usable rubber material may include silicone rubber and ethylene propylene diene rubber.

The base portion 3 is arranged on the lower surface of the resonator case which defines the chamber part of the resonator 2. The base portion 3 is integrated with the resonator case. The base portion 3 includes drain holes 30 and 30. The drain holes 30 and 30 communicate with the inside portion and the outside portion of the chamber of the resonator 2, and perforate through the base portion 3. Water passes through the drain holes 30 and 30, so that water inside the resonator chamber is discharged outward.

The valve body 4 includes a valve main portion 41 having a substantially disk-like shape. The valve main portion 41 has a sheet shape having a substantially constant thickness. However, the thickness of the valve main portion 41 may be thinner from its center toward its peripheral portion. In the present embodiment, the peripheral border shape of the valve main portion 41 is a circle. The valve body 4 further includes, in its center portion, a shaft member 42 which is unified with the valve main portion 41. This shaft member 42 is inserted into an attachment hole 32 located in the central portion of the base portion 3, so that the valve body 4 is fitted to the base portion 3.

Also, the valve body 4 is fitted to the base portion 3 in such a manner as to cover the drain holes 30 and 30. In this manner, the drain valve has a configuration which includes the valve body 4 fitted to the base portion 3. According to the valve body 4 having such a configuration, water having intruded into the intake system is allowed to be discharged, while water from the outside of the intake system is inhibited from intruding. That is, the drain valve acts as a so-called check valve.

Furthermore, the valve main portion 41 has a disk-like and conical surface-like shape. That is, the valve body 4 has a shape like an opened umbrella. Therefore, the valve body 4 can also be likened to an umbrella. In the present embodiment, the drain valve is configured such that when the valve body 4 is fitted to the base portion 3, a surface 41a, of the valve main portion, which corresponds to the inner portion of this umbrella, abuts against the base portion 3. In other words, the surface 41a of the valve main portion 41 having the conical surface-like shape fronts to the conical interior portion through which the central axis of the cone passes through. It can also be said that the surface 41a is a surface located on the side where a handle exists in the umbrella. It is desirable that the base portion 3 abuts against the surface 41a, of the valve main portion of the valve body 4, which corresponds to the inner portion of an umbrella. However, the base portion 3 may abut against a part other than the surface 41a of the valve main portion.

The surface, of the portion of the base portion 3, which faces the valve body 4, has a ring-like region R. This ring-like region R has a diameter DB which is smaller than a diameter DV of the valve main portion 41, and surrounds the drain holes 30 and 30. The valve main portion 41 and the base portion 3 abut against each other at the ring-like region R. The width of the ring-like region R is not particularly limited. However, the width of the ring-like region R is preferably narrow in order to increase the contact pressure against the valve main portion 41. It is noted that the diameter DB of the ring-like region R refers to an outside diameter measured in the width direction of the ring of the ring-like region R. Then, the base portion 3 abuts against the valve main portion 41 at the ring-like region R, so that the valve is closed. That is, the valve main portion 41 and the base portion 3 abut against each other at the ring-like region R, so that the abutted portion is sealed. In this manner, cut off by the drain valve is performed.

Furthermore, in a state in which the valve is closed, a peripheral portion 411, of the valve main portion 41, which is located in the outer periphery portion than the ring-like region R, is spaced apart from the base portion 3. That is, the drain valve is configured such that the valve main portion 41 abuts against the base portion 3 to seal the abutted portion at the ring-like region R, while the valve main portion 41 does not abut against the base portion 3 at the outermost peripheral portion 411.

In the present embodiment, the base portion 3 includes a ring-like projecting portion 31 which projects from the base portion 3 toward the valve main portion 41. The projecting end of the ring-like projecting portion 31 has an inclined surface in its outer portion. The part of this inclined surface corresponds to the above-described ring-like region R. It is noted that any measure other than the ring-like projecting portion 31 or the inclined surface in the present embodiment may be used, as long as the valve main portion 41 and the base portion 3 abut against each other at the ring-like region R while the base portion 3 and the valve main portion 41 do not abut against each other outside the abutted portion.

Also, when the diameter of the ring-like region R is DB, and the diameter of the valve main portion is DV, the ratio between DV and DB preferably satisfies the condition of 1.05≦DV/DB≦1.25.

A manufacturing method of the drain valve used in the present embodiment will be described. A constituent member of an intake system can be manufactured by a known method such as injection molding and blow molding. The base portion 3 of the drain valve can be formed as a portion of the constituent member of the intake system by, for example, injection molding to be integrated with the member of an intake system. Alternatively, the base portion 3 may be separately manufactured with resin, metal plates, or the like, and thereafter the base portion 3 may be integrated with the member of an intake system. The valve body 4 can be efficiently manufactured by injection molding with an elastic material.

The shaft member 42 of the valve body 4 is inserted into the attachment hole 32 of the base portion 3. At this time, the valve body 4 is fitted to the base portion 3 such that an enlarged diameter portion disposed at the tip end portion of the shaft member inhibits the shaft member 42 from dropping from the attachment hole 32 of the base portion. In this manner, the drain valve according to the present embodiment is assembled. As long as the drain valve is assembled such that the valve body does not drop off, other fitting measures, such as screwing the central portion of the valve main portion 41, may be used.

The operation and effect of the air delivery system according to the present embodiment will be described. When water intrudes into a resonator, the weight of water allows the valve body 4 to be opened, thereby to discharge water. Also, when, for example, a vehicle runs in a flood region, and the water level is raised to the outside of a resonator, the valve body 4 is closed. That is, the sealing between the valve main portion 41 and the ring-like region R inhibits water from intruding into the resonator. Furthermore, when the air delivery system according to the present embodiment is used in an intake system of an internal combustion engine, the generation of an unusual noise attributable to intake pulsations can be suppressed.

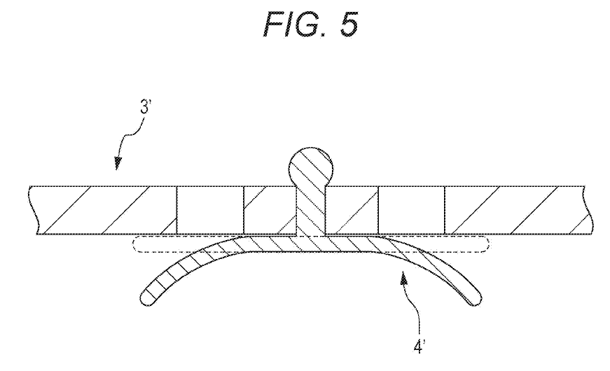

In a known air delivery system, a flutter of the valve body as described below has been caused associated with the opening and closing of the valve body, resulting in the generation of an unusual noise. That is, in a known air delivery system, as indicated by the broken line in FIG. 5, the entire valve body having a substantially flat plate-like shape, including the periphery of the valve body 4′, abuts against the base portion 3′ of the drain valve. Such a valve body is likely to be bent in the central axis direction. In addition, the periphery of the valve body is likely to be deformed to a large extent. For this reason, when a pressure variation is repeatedly inputted to the valve, the valve body is cyclically deformed associated with the pressure variation. It is estimated that the peripheral portion of the valve body 4′ vigorously bumps against the base portion 3′ in such a manner as to whip, resulting in the generation of an unusual noise.

In the air delivery system according to the present embodiment, the valve main portion 41 of the valve body 4 has a conical surface-like shape. Furthermore, the surface of the base portion 3 abuts against the valve main portion 41 at the ring-like region R having a diameter which is smaller than the diameter of the valve main portion, thereby to close the valve. Moreover, in a state in which the valve is closed, the peripheral portion 411, of the valve main portion 41, which is located in the outer periphery portion than the ring-like region R, is spaced apart from the base portion 3, thereby to suppress the generation of an unusual noise.

The conical surface-like shape of the valve main portion 41 reduces the bending of the valve body attributable to the pressure which acts on the valve. Therefore, the valve body is unlikely to be fluttered. This is because the deformation mode of the valve main portion 41 having the conical surface-like shape is different from the deformation mode of the valve main portion having a flat plate-like shape. That is, the peripheral portion of the valve main portion 41 needs to be extensionally deformed in order to deform the valve main portion having the conical surface-like shape in such a manner as to be bent in the central axis direction. Furthermore, increased rigidity, like a shell structure, of the valve main portion 41 to such deformation also has an influence.

Also, in a state in which the valve is closed, the peripheral portion 411 of the valve main portion 41, which is located in the outer periphery portion than the ring-like region R that is a sealing portion, is spaced apart from the base portion 3. This also contributes to the suppression of a flutter of the valve body. First, when the ring-like region R having a diameter which is smaller than the outer diameter of the valve main portion is sealed, the area of a region to be subjected to the pressure variations in the valve body decreases. For this reason, exciting force to act on the valve body decreases. As a result, the valve body becomes unlikely to be fluttered in accordance with internal pressure variations. Furthermore, the peripheral portion 411 of the valve main portion 41 is spaced apart from the base portion 3. For this reason, even when the valve body moves to some extent, the peripheral portion 411, of the valve main portion, having large amplitude is unlikely to bump against the base portion 3. It is estimated that the generation of an unusual noise is suppressed by synergistic action of three effects of increased rigidity, decreased exciting force, and suppressed bumping of the peripheral portion as described above.

Furthermore, when the drain valve is configured such that the base portion 3 abuts against the surface 41a, of the valve main portion 41 having a conical surface-like shape, which corresponds to the inner portion of an umbrella to which the valve main portion 41 is likened, at the ring-like region R, as in the present embodiment, the effect of suppressing the generation of an unusual noise is further enhanced. If the drain valve is configured such that the base portion 3 abuts against the surface, of the valve main portion, which corresponds to the outer portion of an umbrella, at the ring-like region R, the deformation mode like closing an umbrella can release the abutting. On the other hand, when the base portion abuts against the surface, of the valve main portion, which corresponds to the inner portion of an umbrella, the deformation mode like opening an umbrella releases the abutting. The valve main portion 41 is less likely to be subjected to a large deformation by the deformation mode like opening the umbrella than by the deformation mode like closing the umbrella. As a result, the flutter of the valve body depending on the deformation mode of the valve main portion is more effectively reduced by the deformation mode like opening an umbrella. As in the present embodiment, when the drain valve is configured such that the surface 41a, of the valve main portion, which corresponds to the inner portion of an umbrella and the base portion 3 abut against each other at the ring-like region R, the abutting is not released by the deformation mode like closing an umbrella. This suppresses the occurrence of large deformation of the valve body, thereby to more effectively reduce the occurrence of an unusual noise.

Also, when the ratio between DV and DB satisfies the condition of 1.05≦DV/DB≦1.25, provided that the diameter of the ring-like region R is DB, and the diameter of the valve main portion 41 is DV, the effect of suppressing the generation of an unusual noise is further enhanced. The peripheral portion 411, of the valve main portion 41, which is located on the outer periphery side than the ring-like region R, combined with the conical surface-like shape of the valve main portion 41, contributes to an increase in rigidity of the valve main portion 41. Also, when the diameter DB of the ring-like region R is small, the exciting force to the valve body can be decreased. Satisfying the condition of 1.05≦DV/DB enables the effect of increasing rigidity and the effect of reducing exciting force to become significant, and therefore is preferable in terms of the suppression of the generation of an unusual noise. Also, when the DV/DB becomes excessively large, the valve body may not be opened, thereby causing drain performance to become insufficient in some cases. Also, the peripheral portion of the valve main portion is locally deformed in the outer portion than the ring-like region R, thereby to rather become likely, for example, to bump against the base portion 3. For this reason, the condition of DV/DB≦1.25 is preferably satisfied.

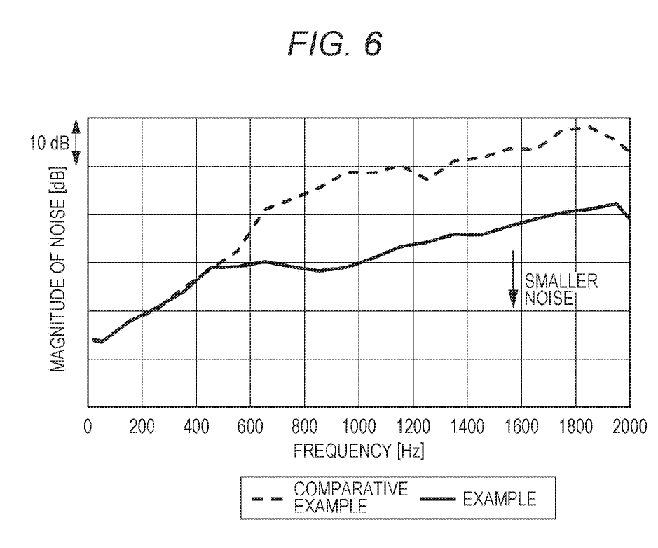

FIG. 6 illustrates the silencing effect by the air delivery system according to the first embodiment. The air delivery system according to the first embodiment as illustrated in FIG. 1, in which the resonator 2 attached to the intake tube 1 includes the drain valve at a lower portion of the resonator 2, was tested (example). The DV/DB in the example is 1.08. Meanwhile, as a comparative example, a known air delivery system which includes the drain valve as illustrated in FIG. 5 was tested in a similar manner.

The outline of the measurement for an unusual noise generated in the valve will be described. One end of the intake tube 1 was connected to a speaker apparatus which can generate acoustic excitation. With this, acoustic excitation was performed so that the resonator was resonated. Specifically, the intake tube 1 was acoustically excited at approximately 60 Hz thereby to resonate the resonator. In such a state, the behavior of the drain valve was observed. Specifically, frequency analysis of a noise measured in the vicinity of the drain valve was performed at the position of 5 cm outside the drain valve. As an example and a comparative example, the tests were performed under the same condition. There was obtained the noise measurement result in FIG. 6.

In drainage performance and water intrusion inhibition performance, there was no difference between the example and the comparative example. In the comparative example, the drain valve was fluttered by pulsations, leading to the generation of an unusual noise. On the other hand, in the example in which the air delivery system according to the first embodiment was used, the opening and closing of the drain valve was visually observed, but an unusual noise caused by a flutter was hardly heard. In the unusual noise measurement result of FIG. 6, the presence and absence of such an unusual noise appears as a difference of the noise level in a frequency range of 600 Hz or more. In this manner, it was confirmed that according to the air delivery system of the first embodiment, the generation of an unusual noise can be suppressed by changing the deformation mode of the valve body associated with the opening and closing of the valve body while maintaining the opening/closing action of the valve.

An embodiment in the present disclosure is not limited to the first embodiment. The first embodiment can be variously modified. Hereinafter, another embodiment of the present disclosure will be described. In the following description, different parts from the first embodiment will be mainly described. Therefore, detailed description of parts similar to the first embodiment will be omitted. Also, parts of the below-described embodiment can be combined with each other. Alternatively, parts of the below-described embodiment can be substituted.

FIG. 4 is a cross-sectional diagram illustrating an example of a structure of a drain valve of an air delivery system according to a second embodiment. In the present embodiment, a clearance portion 35 is formed so that the peripheral portion 411 of the valve main portion is not brought into contact with the base portion 3 outside the ring-like region R where the base portion 3 abuts against the valve main portion 41. This point is different from the first embodiment, but other points are similar to the first embodiment. Even in such a structure, there can be materialized the structure in which the ring-like region R is disposed on the surface of the base portion 3 in such a manner as to surround the drain holes, with a diameter which is smaller than the diameter of the valve main portion 41, so that this ring-like region R abuts against the valve main portion 41 thereby to close the valve, and the peripheral portion 411, of the valve main portion 41, which is located in the outer periphery portion than the ring-like region R, is spaced apart from the base portion 3 in a state in which the valve is closed. In the present embodiment, the generation of an unusual noise associated with the opening and closing of the valve body can also be suppressed.

In the above description of the embodiments, the example in which the drain valve is used in the intake system of an internal combustion engine has been explained. However, the drain valve according to the present invention is not limited to this, and can be used in a general air delivery system. This drain valve functions like a check valve which enables both drain and cut off in each air delivery system. Furthermore, even if a cyclic pressure variation acts on the drain valve, a flutter of the valve body resulting in the generation of an unusual noise is suppressed.

Also, examples of the air delivery system according to an embodiment of the present disclosure may include, other than the above-described intake system of an internal combustion engine, an air delivery system for an air conditioner and an air delivery system for cooling a battery pack. The above-described drain valve can be disposed in, for example, a duct, a case, a chamber, or a silencer in these air delivery systems.

The drain valve included in the air delivery system according to an embodiment of the present disclosure can be favorably used in an intake system of an internal combustion engine. The location where the drain valve is to be attached in the intake system is not particularly limited. This drain valve may be disposed in a part where water is likely to be accumulated, for example, at a lower portion of a chamber of an air cleaner or at a lower portion of a bent part of an intake tube. Alternatively, the drain valve may be disposed at a lower portion of a side branch (a ¼ wave length resonance tube). The type and use of the internal combustion engine are also not particularly limited. Also, the internal combustion engine may be for automobiles or motorcycles. Furthermore, this internal combustion engine may be built-in or portable. Also, the internal combustion engine may be of either a 4-stroke type or a 2-stroke type.

Also, the direction and posture with which the drain valve included in an air delivery system according to an embodiment of the present disclosure is attached are also not particularly limited. From the viewpoint of more surely performed drainage, the drain valve is preferably disposed such that the central axis of the valve body is substantially in the vertical direction. However, the direction and posture are not limited to this, and the drain valve may be disposed such that the central axis of the valve body is obliquely tilted or is horizontal.

Also, in the air delivery system according to an embodiment of the present disclosure, a cylindrical tube portion may be disposed around the base portion in such a manner as to surround the drain valve, or the base portion may be swollen and formed so that the outermost portion of the base portion bulges into a cylindrical shape. These can suppress the occurrence of a phenomenon in which an air flow or a water flow directly hits against the valve body of the drain valve thereby causing the valve body to curl up.

The air delivery system according to an embodiment of the present disclosure may include the following first to third drain valves.

The first drain valve is a drain valve used in an air delivery system, which includes a flexible valve body made of an elastic material, and a base portion to which the valve body is attached. The base portion includes a drain hole through which water passes, and the valve body is attached to the base portion in such a manner as to cover the drain hole. The drain valve is configured such that the valve body allows water having intruded into the air delivery system to be discharged, while inhibiting water from the outside of the air delivery system from intruding. The valve body includes a valve main portion having a substantially disk-like shape, and is attached to the base portion at the center portion of the valve main portion having a conical surface-like shape. On a surface of the base portion, there is disposed a ring-like region which surrounds the drain hole with a diameter which is smaller than a diameter of the valve main portion. This ring-like region abuts against the valve main portion thereby to close the valve, and the peripheral portion, of the valve main portion, which is located in the outer periphery portion than the ring-like region, is spaced apart from the base portion in a state in which the valve is closed.

The second drain valve is the above-described first drain valve which is configured such that the surface, of the valve main portion, which corresponds to the inner portion of an umbrella to which the valve main portion having the conical surface-like shape is likened, abuts against the ring-like region of the base portion.

The third drain valve is the above-described first or second drain valve in which when the diameter of the ring-like region is DB, and the diameter of the valve main portion is DV, the ratio between DV and DB is 1.05≦DV/DB≦1.25.

The air delivery system according to the present disclosure, when used in an intake system of an internal combustion engine for automobiles, can discharge water having intruded into the system, and therefore has high industrial use value.

The foregoing detailed description has been presented for the purposes of illustration and description. Many modifications and variations are possible in light of the above teaching. It is not intended to be exhaustive or to limit the subject matter described herein to the precise form disclosed. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims appended hereto.

What is claimed is:

1. An air delivery system comprising a drain valve, wherein
the drain valve includes a flexible valve body made of an elastic material, and a base portion,
the valve body includes a valve main portion having a substantially disk-like and conical surface-like shape,
the base portion includes a drain hole through which water passes, and a ring-like region on a surface of the base portion,
the ring-like region has a diameter which is smaller than a diameter of the valve main portion having the substantially disk-like shape, and surrounds the drain hole,
the valve body is fitted to the base portion such that the valve main portion covers the drain hole, and allows water having intruded into the air delivery system to be discharged while inhibiting water from the outside of the air delivery system from intruding, and
when the drain valve is closed,
the base portion abuts against the valve main portion at the ring-like region, and a peripheral portion, of the valve main portion, which is located in the outer periphery portion than the ring-like region, is spaced apart from the surface of the base portion.

2. The air delivery system according to claim 1, wherein the base portion abuts against a surface, of the valve main portion having the conical surface-like shape likened to an umbrella, which corresponds to the inside of the umbrella.

3. The air delivery system according to claim 1, wherein when the diameter of the ring-like region is DB, and the diameter of the valve main portion is DV, the ratio between the DV and the DB satisfies the condition of 1.05≦DV/DB≦1.25.

4. The air delivery system according to claim 2, wherein when the diameter of the ring-like region is DB, and the diameter of the valve main portion is DV, the ratio between the DV and the DB satisfies the condition of 1.05≦DV/DB≦1.25.
